(19) United States
(12) Patent Application Publication
(10) Pub. No.: US 2010/0283480 A1
(43) Pub. Date: Nov. 11, 2010

(54) TEST APPARATUS, TEST METHOD, AND DEVICE

(75) Inventors: Kenichi NAGATANI, Gunma (JP); Masahiro ISHIDA, Miyagi (JP)

Correspondence Address: Masao Yoshimura, 333 W. El Camino Real, Suite 380, Sunnyvale, CA, 94087, US

(73) Assignee: ADVANTEST CORPORATION, Tokyo (JP)

(21) Appl. No.: 12/767,749

(22) Filed: Apr. 26, 2010

(30) Foreign Application Priority Data
May 8, 2009 (JP) 2009-113842

(51) Int. Cl. H01H 31/02

(52) U.S. Cl. 324/555

(57) ABSTRACT

Provided is a test apparatus that tests a device under test, wherein the device under test includes an internal circuit that generates a plurality of internal clocks having different phases based on a reference clock provided thereto, selects from among the internal clocks an internal clock having a predetermined relative phase with respect to an input signal having a frequency substantially equal to that of the internal clocks, and samples the input signal according to the selected internal clock. The test apparatus comprises a selection control section that fixes the internal clock selected by the internal circuit; a phase control section that, with the selection of the internal clock being fixed by the selection control section, sequentially shifts the phase of the internal clock by inputting the reference clock to the device under test while sequentially shifting the phase of the reference clock outside of the device under test; and a measuring section that measures a characteristic of at least one of the input signal and the internal circuit, based on the sampling result of the internal circuit.

### BACKGROUND

1. Technical Field

The present invention relates to a test apparatus, a test method, and a device.

2. Related Art

A known method for measuring characteristics such as jitter amount and an eye opening in a signal generated by a device involves providing a variable delay circuit that sequentially delays the signal under measurement within the device, and measuring the bit error rate for each delay amount. Another known method involves measuring jitter by sampling the signal under measurement with a signal whose frequency is a non-integer multiple of the frequency of the signal under measurement. The invention disclosed in Japanese Application Publication No. 2007-127645 is recognized as related art.

When the variable delay circuit is provided within the device, however, it is difficult to accurately set the delay time due to the effect of the processes, voltage, temperature, and the like of the device. As a result, errors occur in the measurement results for jitter and the like. Furthermore, when sampling the signal under measurement with a signal whose frequency is a non-integer multiple of the frequency of the signal under measurement, it is necessary to perform a data computation process after the sampling, and this causes an increase in the circuit size.

### SUMMARY

Therefore, it is an object of an aspect of the innovations herein to provide a test apparatus, a test method, and a device, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary test apparatus may include a test apparatus that tests a device under test, wherein the device under test includes an internal circuit that generates a plurality of internal clocks having different phases based on a reference clock provided thereto, selects from among the internal clocks an internal clock having a predetermined relative phase with respect to an input signal having a frequency substantially equal to that of the internal clocks, and samples the input signal according to the selected internal clock, and the test apparatus comprises a selection control section that fixes the internal clock selected by the internal circuit; a phase control section that, with the selection of the internal clock being fixed by the selection control section, sequentially shifts the phase of the internal clock by inputting the reference clock to the device under test while sequentially shifting the phase of the reference clock outside of the device under test; and a measuring section that measures a characteristic of at least one of the input signal and the internal circuit, based on the sampling result of the internal circuit.

The device under test outputs a comparison result obtained by comparing the sampling result of the input signal to a predetermined expected value, and the measuring section measures the characteristic of the input signal based on the comparison result. The measuring section measures at least one of jitter and an eye opening of the input signal, based on the comparison result. The device under test may further include a BIST control circuit that tests the internal circuit and an input/output port that transfers data between the BIST control circuit and the outside, and the selection control section controls the internal circuit via the input/output port and the BIST control circuit to fix the internal clock selected by the internal circuit.

The test apparatus may further comprise a signal generating section that operates according to an operation clock supplied thereto to generate the input signal and input the input signal to the device under test; an operation clock generating section that generates the operation clock and inputs the operation clock to the signal generating section; and a reference clock generating section that generates the reference clock in synchronization with the operation clock and inputs the reference clock to the phase control section. The device under test may further include a signal generating section that operates according to an operation clock provided thereto to generate the input signal and loop the input signal back to the internal circuit, and the test apparatus may further comprise an operation clock generating section that generates the operation clock and inputs the operation clock to the signal generating section; and a reference clock generating section that generates the reference clock in synchronization with the operation clock and inputs the reference clock to the phase control section.

The reference clock generating section may generate a clock with less jitter than the operation clock generated by the operation clock generating section. The test apparatus may further comprise a signal generating section that generates the input signal and generates the reference clock in synchronization with the input signal, and the phase control section may control the phase of the reference clock generated by the signal generating section and input the reference clock to the device under test.

The device under test may further include a signal generating section that generates the input signal, loops the input signal back to the internal circuit, and generates the reference clock in synchronization with the input signal, and the phase control section may receive, outside of the device under test, the reference clock generated by the signal generating section, control the phase of the received reference clock, and input the reference clock to the device under test. The selection control section may sequentially change which internal clock is fixed, and the measuring section may measure an eye opening of the input signal for each internal clock and calculate a phase difference for each internal clock based on a position of the eye opening.

The internal circuit may further comprises a multi-channel sampler that outputs a plurality of sampling results obtained by sampling the input signal according to each internal clock; a transition detecting section that detects, for each internal clock, whether the sampling result in each cycle of the input signal transitions between the internal clock and an internal clock with an adjacent phase; a clock selecting section that selects one of the internal clocks based on the detection results of the transition detecting section; and a deserializer that samples the input signal according to the selected internal clock, to convert the input signal into a parallel signal, and, for each phase of the reference clock, the measuring section may measure jitter of the input signal based on a number of transitions of the sampling result detected by the transition detecting section for each internal clock.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows exemplary configurations of a test apparatus 100 and a device under test 200 according to a first embodiment of the present invention.

FIG. 2 shows a process performed by the measuring section 140 for measuring the jitter amount.

FIG. 3 shows configurations of the test apparatus 100 and the device under test 200 according to another embodiment of the present invention.

FIG. 4 shows configurations of the test apparatus 100 and the device under test 200 according to another embodiment of the present invention.

FIG. 5 shows configurations of the test apparatus 100 and the device under test 200 according to another embodiment of the present invention.

FIG. 6 shows configurations of the test apparatus 100 and the device under test 200 according to another embodiment of the present invention.

FIG. 7 shows a configuration of the signal generating section 170.

FIG. 8 shows configurations of the test apparatus 100 and the device under test 200 according to another embodiment of the present invention.

FIG. 9 describes a method for measuring the phase differences among the internal clocks 312.

FIG. 10 shows a configuration of the internal circuit 300 according to another embodiment of the present invention.

FIG. 11 shows configurations of the test apparatus 100, a testing device 250, and an external device 500 according to another embodiment of the present invention.

FIG. 12 shows configurations of the test apparatus 100 and the device under test 200 according to another embodiment of the present invention.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

Hereinafter, some embodiments of the present invention will be described. The embodiments do not limit the invention according to the claims, and all the combinations of the features described in the embodiments are not necessarily essential to means provided by aspects of the invention.

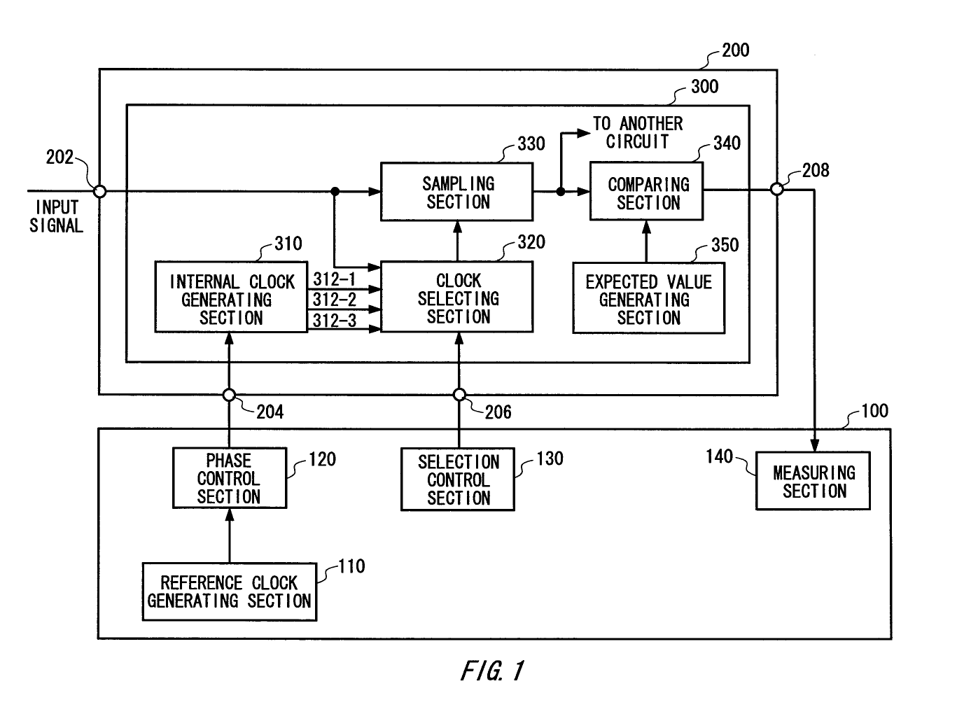

FIG. 1 shows exemplary configurations of a test apparatus 100 and a device under test 200 according to a first embodiment of the present invention. The test apparatus 100 tests the device under test 200. The test apparatus 100 may input to the device under test 200 an input signal having a prescribed pattern. The test apparatus 100 may judge acceptability of the device under test 200 based on a signal output by the device under test 200 in response to the input signal.

The device under test 200 includes an internal circuit 300. The device under test 200 also includes an input pin 202, an input pin 204, an input pin 206, and an output pin 208. The internal circuit 300 includes an internal clock generating section 310, a clock selecting section 320, a sampling section 330, a comparing section 340, and an expected value generating section 350. The internal clock generating section 310 generates a plurality of internal clocks 312 with different phases, based on a reference clock provided thereto via the input pin 204. For example, the internal clock generating section 310 may generate three internal clock 312-1 to 312-3 to each have a different phase relative to the reference clock received via the input pin 204. The phase difference between each pair of internal clocks 312 is less than the period, i.e. bit rate, of the input signal.

During normal operation, the clock selecting section 320 selects from among the internal clocks 312 an internal clock 312 that has a prescribed relative phase with respect to the input signal having substantially the same frequency as the internal clocks 312. Specifically, the clock selecting section 320 samples the input signal with the internal clock 312-1, the internal clock 312-2, and the internal clock 312-3. The clock selecting section 320 selects the internal clock 312 from among these internal clocks 312 that has the greatest phase difference relative to the phase of an end of a unit of data in the input signal, based on the sampling results. As a result, the clock selecting section 320 can select the internal clock 312 that is closest to a center of the eye opening of the input signal.

The phase differences among the internal clocks 312 are each less than the period of the input signal, and so the clock selecting section 320 can sample the input signal using the over-sampling technique. In other words, the clock selecting section 320 can quickly input to the sampling section 330 the internal clock 312 whose phase is closest to the center of the eye opening, by using the internal clocks 312 generated by the internal clock generating section 310.

The clock selecting section 320 inputs the selected internal clock 312 to the sampling section 330. The sampling section 330 samples the input signal according to the internal clock 312 selected by the clock selecting section 320, and inputs the sampling results to the comparing section 340. The sampling section 330 performs a deserialization process to convert the serial data of the sampling results into parallel data, and inputs the parallel data to the comparing section 340. During normal operation, which does not involve testing the jitter or the like of the input signal, the sampling section 330 may output the sampling results to the outside of the device under test 200 or to another circuit within the device under test 200.

The comparing section 340 compares the sampling results output by the sampling section 330 to a prescribed expected value generated by the expected value generating section 350. When the test apparatus 100 tests the device under test 200, the comparing section 340 may input the comparison results to the test apparatus 100.

The test apparatus 100 includes a reference clock generating section 110, a phase control section 120, a selection control section 130, and a measuring section 140. When the test apparatus 100 tests the device under test 200, the selection control section 130 fixes the internal clock 312 selected by the internal circuit 300. The selection control section 130 may fix the internal clock 312 by inputting a logic value for selecting the internal clock 312 to the clock selecting section 320, via the input pin 206. The input pin 206 is not used during normal operation of the device under test 200, and is used only when the test apparatus 100 tests the device under test 200. Furthermore, the selection control section 130 may generate a logic value for selecting the internal clock 312 under the control of a microcontroller that operates according to a program. When the logic value for selecting the internal clock is input from the selection control section 130, the clock selecting section 320 gives priority to the instructions corresponding to the logic signal output by the selection control section 130, regardless of the selection results from the clock selecting section 320 during normal operation.

The selection control section 130 may select one of the internal clock 312-1, the internal clock 312-2, and the internal clock 312-3. For example, the selection control section 130 may select the internal clock 312 that was selected immediately therebefore by the clock selecting section 320. Instead, the selection control section 130 may select the internal clock 312 whose initial phase has the greatest phase difference relative to the phase at which the logic value of the input signal transitions.

The reference clock generating section 110 generates the reference clock. The reference clock generating section 110 may generate the reference clock by dividing a signal input from an external device such as a crystal oscillator. With the internal clock 312 selected by the selection control section 130 being fixed, the phase control section 120 sequentially shifts the phase of the reference clock outside of the device under test 200. The phase control section 120 may sequentially shift the phase of the reference clock by intervals that are each less than the period of the input signal received from the device under test 200. For example, if the period of the input signal is 100 ps, the phase control section 120 may shift the phase of the reference clock in units of 1 ps. Instead, the phase control section 120 may sequentially shift the phase of the reference clock over a period that is greater than or equal to one period of the input signal.

The phase control section 120 sequentially shifts the phase of the internal clock 312 by inputting to the device under test 200 a reference clock whose phase is sequentially shifted. Specifically, when the phase control section 120 sequentially shifts the phase of the reference clock in units of 1 ps, the internal clock 312 output by the internal clock generating section 310 is also sequentially shifted in units of 1 ps.

The measuring section 140 measures a characteristic of at least one of the input signal and the internal circuit 300, based on the sampling results of the internal circuit 300. For example, the measuring section 140 may measure at least one of jitter and an eye opening of the input signal, based on results obtained by the comparing section 340 comparing the sampling results to the expected value.

By sequentially shifting the phase of the internal clock 312, the timing of the internal clock 312 changes relative to the transition timing of the input signal. When the timing of the internal clock 312 does not fulfill prescribed conditions for setup time and hold time of a latch circuit within the sampling section 330, the sampling results of the input signal do not match the expected value. When a comparison result output by the comparing section 340 indicates that a sampling result of the input signal does not match the expected value, the measuring section 140 may judge this sampling result to be a “fail.” Furthermore, when a comparison result output by the comparing section 340 indicates that a sampling result of the input signal does match the expected value, the measuring section 140 may judge this sampling result to be a “pass.” The measuring section 140 may calculate the jitter characteristic from a probability density function generated based on the rate of occurrence of “fail” judgments.

The measuring section 140 may measure a characteristic of the internal circuit 300 by measuring the eye opening based on the comparison results from the comparing section 340. For example, when an input signal having a known jitter amount is input to the device under test 200, the internal circuit 300 can be considered as being strongly affected by the jitter if the eye opening measured by the measuring section 140 is less than a prescribed value. The measuring section 140 may then judge whether the jitter tolerance of the internal circuit 300 fulfills a reference value, based on the results obtained by comparing the eye opening measured by the measuring section 140 to a prescribed value.

The comparing section 340 may include a fail bit counter that counts the number of generated “fails” indicating a mismatch between a sampling result and the prescribed value. In this case, instead of inputting the comparison result at each sampling timing into the measuring section 140, the comparing section 340 may input an analysis result into the measuring section 140 after a prescribed number of samplings are completed.

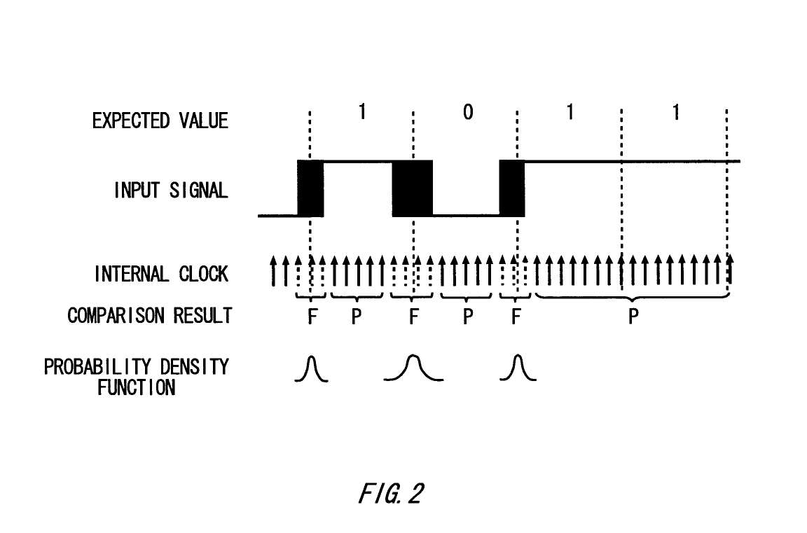

FIG. 2 shows a process performed by the measuring section 140 for measuring the jitter amount. In FIG. 2, the “expected value” is a logic value of “1” or “0” generated by the expected value generating section 350. The expected value generating section 350 generates this expected value in synchronization with the input signal pattern. In FIG. 2, the expected value changes in the order of “1,” “0,” “1,” “1” in synchronization with the input signal pattern.

The “input signal” is a signal input via the input pin 202 and has a logic value of “1” or “0.” The logic value of the input signal transitions at prescribed periods. Jitter occurs at the timing at which the logic value of the “input signal” switches.

The “internal clock” indicates the internal clock 312 output by the clock selecting section 320. Since the phase control section 120 sequentially shifts the phase by intervals that are each shorter than the period of the input signal, the internal clocks 312 are generated at different phases relative to the input signal while the test apparatus 100 tests the device under test 200.

The “comparison result” indicates results obtained by comparing the results of sampling the input signal with the internal clock 312 to the expected value. Near a timing at which the logic value of the input signal transitions, the input signal differs from the expected value, and so the comparison result is “F (fail).” At a timing at which the logic value of the input signal does not transition, the input signal matches the expected value, and so the comparison result is “P (pass).”

The “probability density function” is a histogram of the occurrence rate of “fails” at each sampling timing, occurring when the input signal of FIG. 2 is measured a plurality of times. The occurrence rate of “fails” is highest near the data transition timing of the input signal. This rate becomes lower further from the data transition timing of the input signal.

The measuring section 140 may calculate the probability density function based on the comparison results acquired from the comparing section 340. The measuring section 140 may analyze the jitter distribution, jitter amount, jitter type, and the like based on the calculated probability density function. For example, the measuring section 140 may separate a random jitter component from a deterministic jitter component by comparing a probability density function distribution and a prescribed distribution to identify the deterministic jitter. By including a fail counter that counts the number of “fails” generated by the comparing section 340, the comparing section 340 can generate the probability density function. The measuring section 140 may measure the jitter characteristic based on the probability density function generated by the comparing section 340.

As described above, with the test apparatus 100 and the device under test 200 of the present embodiment, the test apparatus 100 shifts the phase of the sampling clock outside of the device under test 200. As a result, the test apparatus 100 can accurately measure characteristics such as jitter of the input signal without being affected by the processes, voltage, temperature, and the like of the device.

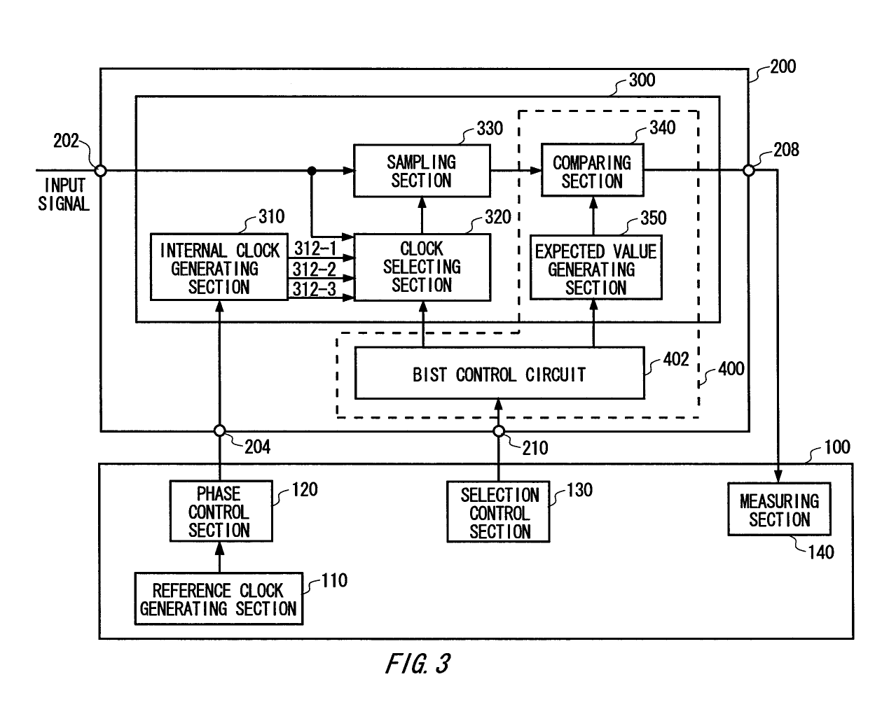

FIG. 3 shows configurations of the test apparatus 100 and the device under test 200 according to another embodiment of the present invention. The device under test 200 of FIG. 3 includes, in addition to the configuration of the device under test 200 shown in FIG. 1, a BIST (Built In Self-Test) control circuit 402 that tests the internal circuit 300 and an input/output port 210 that transfers data between the device under test 200 and the outside. The BIST control circuit 402 controls the comparing section 340 and the expected value generating section 350. The BIST control circuit 402, the comparing section 340, and the expected value generating section 350 function as a BIST section 400 that performs a self-diagnostic test based on the sampling results of the sampling section 330.

The BIST control circuit 402 also controls the clock selecting section 320. For example, the BIST control circuit 402 may control the clock selecting section 320 during a self-diagnostic test of the device under test 200 to select a clock used for testing.

The selection control section 130 controls the internal circuit 300 via the input/output port 210 and the BIST control circuit 402 to fix the internal clock 312 selected by the internal circuit 300. The BIST control circuit 402 operates according to the instructions of the selection control section 130 when a clock selection signal is input from the selection control section 130. The input/output port 210 may be a general interface such as a data bus. Since the selection control section 130 selects the clock via the BIST control circuit 402, there is no need to provide the specialized input pin 206 for connecting the selection control section 130 and the clock selecting section 320.

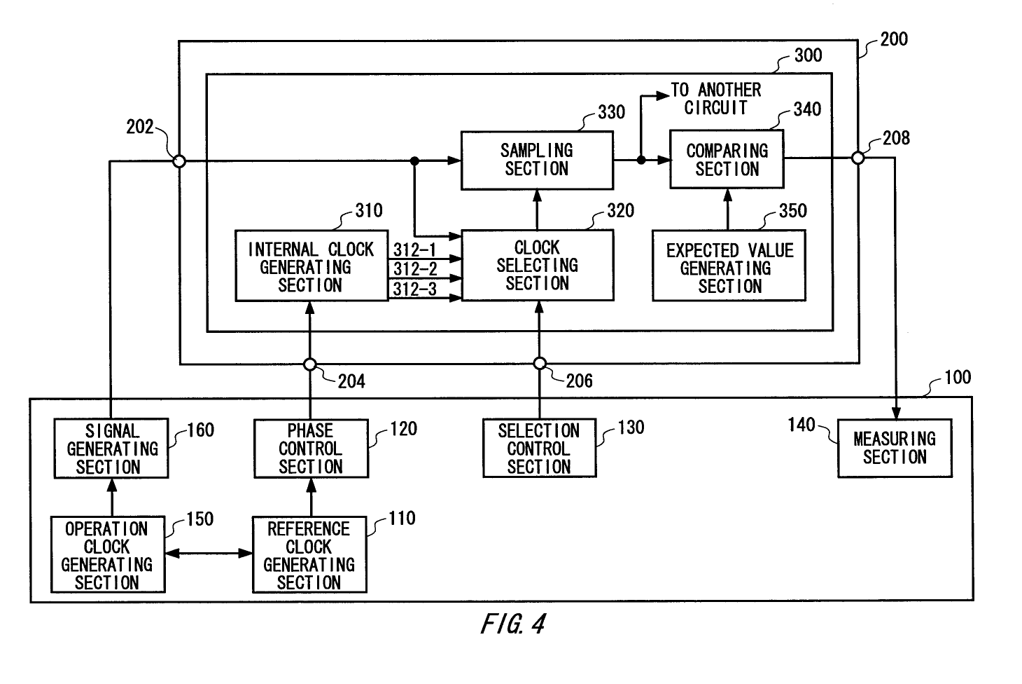

FIG. 4 shows configurations of the test apparatus 100 and the device under test 200 according to another embodiment of the present invention. The test apparatus 100 of FIG. 4 includes, in addition to the configuration of the test apparatus 100 shown in FIG. 1, an operation clock generating section 150 and a signal generating section 160. The signal generating section 160 operates according to an operation clock supplied thereto, to generate the input signal and input the input signal to the device under test 200. The operation clock generating section 150 generates the operation clock and inputs the operation clock to the signal generating section 160. The reference clock generating section 110 generates the reference clock in synchronization with the operation clock, and inputs the reference clock to the phase control section 120.

The reference clock generating section 110 and the operation clock generating section 150 may include a phase-locked loop circuit. The operation clock generating section 150 may use this phase-locked loop circuit to generate the operation clock in synchronization with the reference clock output by the reference clock generating section 110. In the same way, the reference clock generating section 110 may generate the reference clock in synchronization with the operation clock output by the operation clock generating section 150.

The reference clock generating section 110 may generate a clock with less jitter than the clock generated by the operation clock generating section 150. If the internal clock generating section 310 does not include the phase-locked loop circuit, the error in the measurement results due to the jitter increases. Therefore, the measurement accuracy can be increased by decreasing the jitter of the reference clock output by the reference clock generating section 110 to be less than the jitter of the operation clock output by the reference clock generating section 110.

Instead of shifting the phase of the reference clock with the phase control section 120, the test apparatus 100 may shift the phase of the input signal. Specifically, the operation clock generating section 150 may generate the operation clock to have a phase that is sequentially shifted relative to the reference clock generated by the reference clock generating section 110. For example, if the period of the input signal is 100 ps, the operation clock generating section 150 may sequentially shift the operation clock in units of 1 ps. Furthermore, the operation clock generating section 150 may sequentially shift the phase of the operation clock over a period that is greater than or equal to one period of the input signal.

The phase of the input signal may be sequentially shifted by the signal generating section 160 generating a signal at a timing that is delayed by a prescribed amount relative to the input operation clock. The signal generating section 160 can sequentially shift the phase of the input signal relative to the reference clock by sequentially switching the delay time.

The test apparatus 100 may sequentially shift the phases of both the reference clock and the input signal simultaneously. The test apparatus 100 can set the relative phase between the reference clock and the input signal with more flexibility by selecting different coprime values as the minimum phase shift intervals between the reference clock and the input signal. For example, if the minimum phase shift interval of the reference clock is 2 ps and the minimum phase shift interval of the input signal is 3 ps, the test apparatus 100 can set values of 5 ps, 7 ps, etc. as the relative phase.

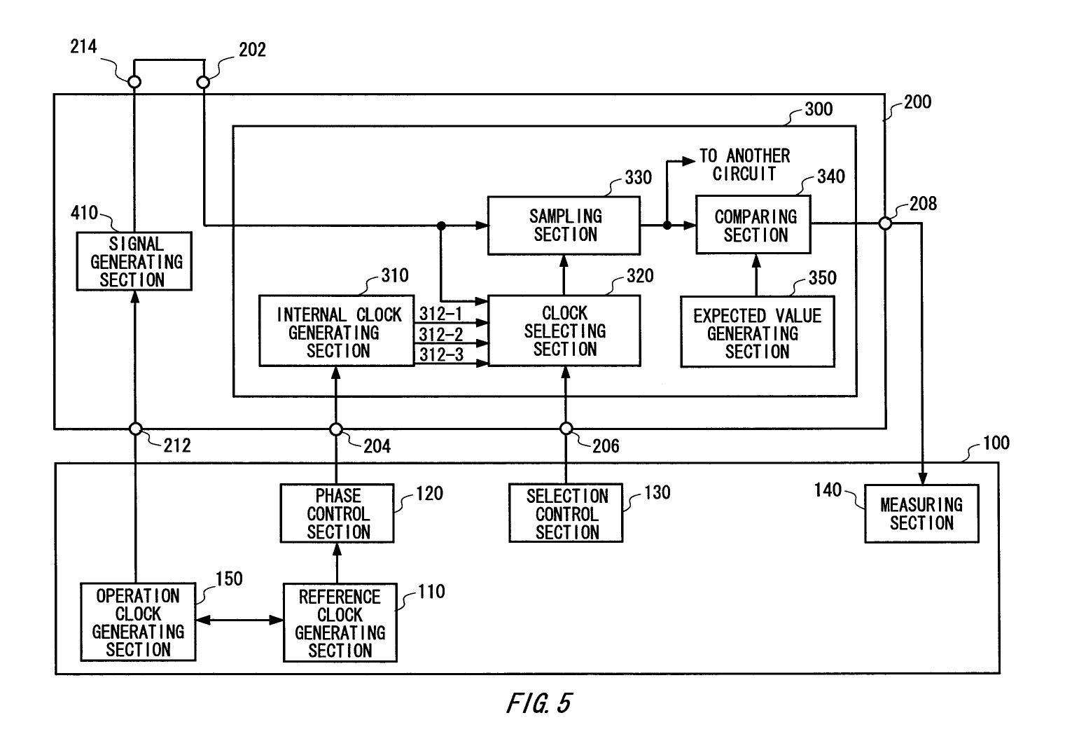

FIG. 5 shows configurations of the test apparatus 100 and the device under test 200 according to another embodiment of the present invention. The device under test 200 of FIG. 5 includes, in addition to the configuration of the device under test 200 shown in FIG. 1, a signal generating section 410 that operates according to an operation clock supplied thereto to generate the input signal and loop the input signal back to the internal circuit 300. The operation clock generating section 150 generates the operation clock and inputs the operation clock to the signal generating section 410. The reference clock generating section 110 generates the reference clock in synchronization with the operation clock, and inputs the reference clock to the phase control section 120.

Specifically, the signal generating section 410 generates the input signal in synchronization with the operation clock received from the operation clock generating section 150 via the input pin 212. The signal generating section 410 outputs the generated input signal to the output pin 214. When the output pin 214 is connected to the input pin 202 outside the device under test 200, the input signal generated by the signal generating section 410 is input to the sampling section 330 via the output pin 214 and the input pin 202. The signal generating section 410 may input the input signal directly to the sampling section 330, without using the output pin 214 and the input pin 202.

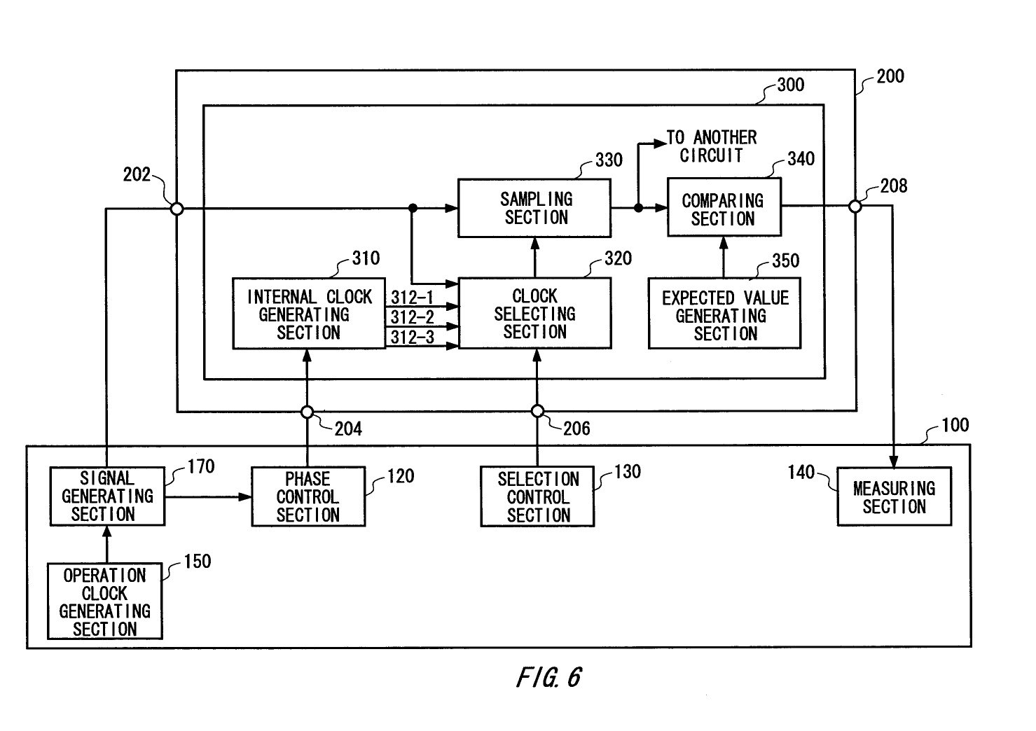

FIG. 6 shows configurations of the test apparatus 100 and the device under test 200 according to another embodiment of the present invention. The test apparatus 100 of FIG. 6 includes, in addition to the configuration of the test apparatus 100 shown in FIG. 1, a signal generating section 170. The signal generating section 170 generates an input signal and a reference clock in synchronization with the input signal. The phase control section 120 controls the phase of the reference clock generated by the signal generating section 170 and inputs the reference clock to the device under test 200.

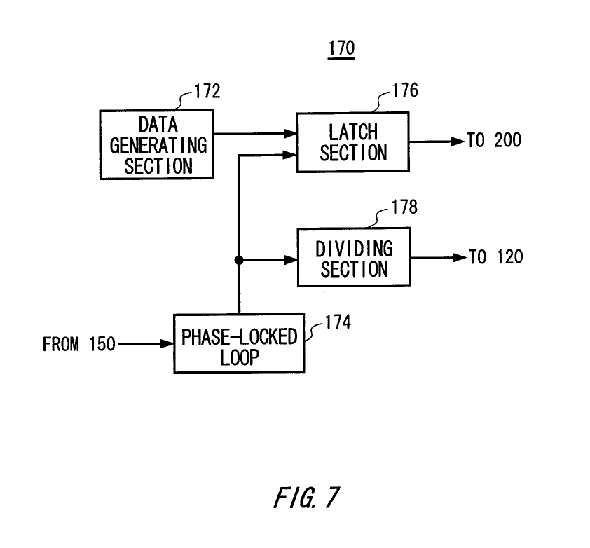

FIG. 7 shows a configuration of the signal generating section 170. The signal generating section 170 includes a data generating section 172, a phase-locked loop 174, a latch section 176, and a dividing section 178. The phase-locked loop 174 generates a clock in synchronization with the operation clock received from the operation clock generating section 150, and inputs this clock to the latch section 176 and the dividing section 178. The latch section 176 latches the data generated by the data generating section 172 using the clock generated by the phase-locked loop 174, and inputs the latched data to the device under test 200.

The dividing section 178 inputs to the phase control section 120 a reference clock obtained by dividing the clock generated by the phase-locked loop 174. The latch section 176 and the dividing section 178 operate in synchronization with the clock generated by the phase-locked loop 174, and so the phase control section 120 receives the reference clock in synchronization with the input signal input to the device under test 200.

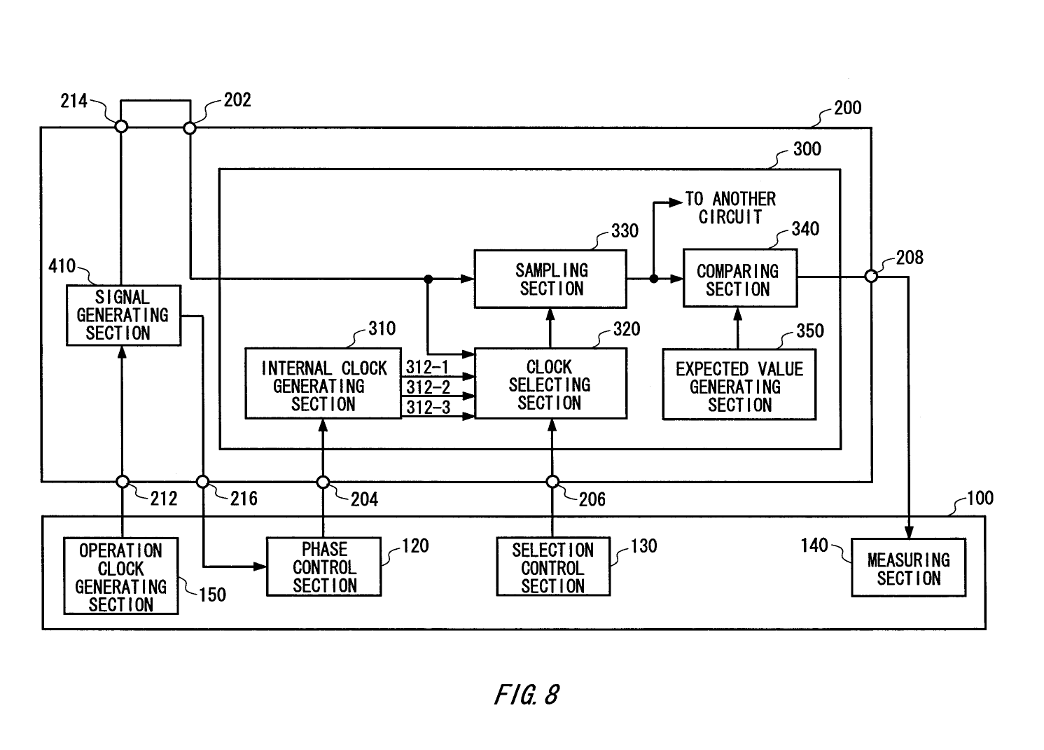

FIG. 8 shows configurations of the test apparatus 100 and the device under test 200 according to another embodiment of the present invention. The device under test 200 of FIG. 8 includes, in addition to the configuration of the device under test 200 shown in FIG. 1, a signal generating section 410 that generates an input signal, loops the input signal back to the internal circuit 300, and generates a reference clock in synchronization with the input signal. The phase control section 120 receives the reference clock generated by the signal generating section 410 outside of the device under test 200, controls the phase of the received reference clock, and inputs the reference clock to the device under test 200. The phase control section 120 may receive the reference clock generated by the signal generating section 410 via the output pin 216, and input the clock whose phase is controlled to the device under test 200 via the input pin 204.

The signal generating section 410 may have the same configuration as the signal generating section 170 shown in FIG. 7. The signal generating section 410 may loop the generated input signal back to be input to the sampling section 330 via the output pin 214 and the input pin 202. According to the present embodiment, the device under test 200 can generate the input signal internally, and can generate the internal clocks 312 having phases that are shifted with high precision and without being affected by the processes, temperature, or the like of the device.

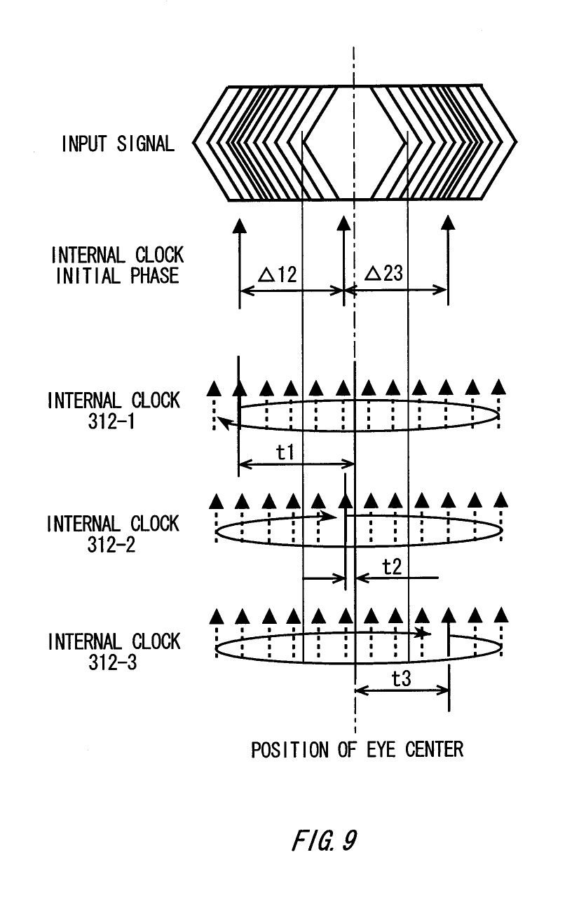

FIG. 9 describes a method for measuring the phase differences among the internal clocks 312. During normal operation, the device under test 200 selects the internal clock 312 whose phase is closest to the center of the eye opening from among the plurality of internal clocks, and samples the input signal.

When the phase of the selected internal clock 312 matches the center of the eye opening of the input signal, the sampling section 330 can sample the input signal at a timing that is furthest from the timing at which the logic value of the input signal transitions. Accordingly, even when the input signal includes jitter, there is a high probability that the sampling result matches the expected value. In other words, the jitter tolerance of the device under test 200 is high.

On the other hand, when the phase of the selected internal clock 312 is distant from the center of the eye opening of the input signal, the probability that the sampling result and the expected value do not match is increased due to the jitter in the input signal. In other words, the jitter tolerance of the device under test 200 is lowered. Accordingly, when using the over-sampling technique, the clock selecting section 320 can improve the jitter tolerance by selecting the internal clock 312 whose phase is furthest from the timing at which the logic value of the input signal transitions.

When the phases of the internal clock 312-1 and the internal clock 312-3 are close to the edges of the eye opening of the input signal and the phase of the internal clock 312-2 is at an intermediate point between the phases of the internal clock 312-1 and the internal clock 312-3, the phase of the internal clock 312-2 substantially matches the phase of the center of the eye opening. However, when the phase differences between adjacent pairs of internal clocks 312 are not equal to each other, the phase of the internal clock 312-2 does not match the phase of the center of the eye opening.

For example, in FIG. 9, the phase difference 412 between the internal clock 312-1 and the internal clock 312-2 is less than the phase difference 423 between the internal clock 312-2 and the internal clock 312-3. In such a case, the phase of the internal clock 312-2 is at a distance from the center of the eye opening, despite being closer to the center of the eye opening than the phases of the internal clock 312-1 and the internal clock 312-3. As a result, the jitter tolerance of the device under test 200 is worse than when the phase of the internal clock 312-2 is at the center of the eye opening.

Therefore, the test apparatus 100 measures the phase difference between each pair of adjacent internal clocks 312. The test apparatus 100 may measure the phase differences between the internal clocks 312 using the following technique. The selection control section 130 sequentially changes which internal clock 312 is fixed. The measuring section 140 measures the eye opening of the input signal for each internal clock 312. The measuring section 140 calculates the phase difference for each internal clock 312 based on the corresponding eye opening position.

Specifically, the selection control section 130 selects one of the internal clock 312-1, the internal clock 312-2, and the internal clock 312-3. For example, the selection control section 130 selects the internal clock 312-1. When the phase control section 120 sequentially shifts the phase of the reference clock, the phase of the selected internal clock 312-1 is also shifted, and the sampling section 330 samples the input signal at the shifted timings.

The comparing section 340 compares the sampling results to the expected values, and inputs the comparison results to the measuring section 140. The measuring section 140 measures the center position of the eye opening based on the comparison results received from the comparing section 340, and then calculates the phase difference t1 between the initial phase of the internal clock 312 selected by the selection control section 130 and the center position of the eye opening. The initial phase is the phase of the internal clock 312 when the amount of the phase shift by the phase control section 120 is zero.

Next, the selection control section 130 sequentially selects the internal clock 312-2 and the internal clock 312-3. The measuring section 140 calculates the phase differences t2 and t3 between the initial phase and the center position of the eye opening for the internal clock 312-2 and the internal clock 312-3, respectively.

Next, the measuring section 140 calculates the phase difference between each pair of adjacent internal clocks 312. Specifically, the measuring section 140 calculates the phase difference Δ12 between the internal clock 312-1 and the internal clock 312-2 by subtracting t2 from t1. In the same way, the measuring section 140 calculates the phase difference Δ23 between the internal clock 312-2 and the internal clock 312-3 by subtracting t2 from t3. The measuring section 140 may switch the judgment threshold value for the test results relating to the jitter characteristic of the device under test 200, based on the phase difference between Δ12 and Δ23.

In the manner described above, the test apparatus 100 and the device under test 200 according to the present embodiment can measure the phase differences of the internal clocks 312 without injecting jitter into the input signal and measuring the bit error rate. Accordingly, the phase differences among the internal clocks 312 can be measured without using an input signal generator that can inject jitter.

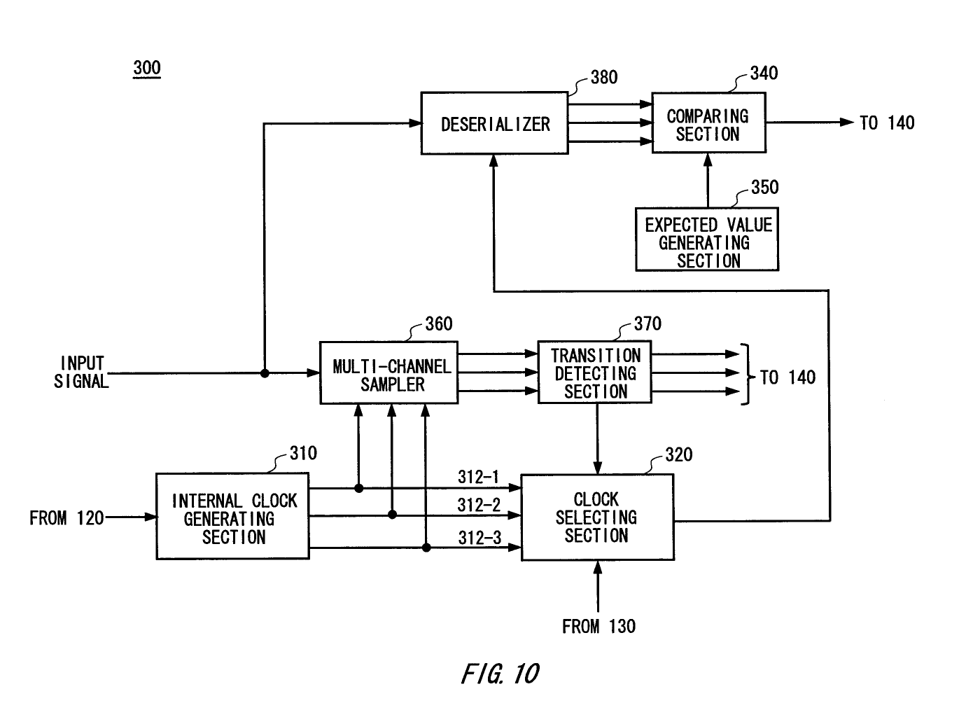

FIG. 10 shows a configuration of the internal circuit 300 according to another embodiment of the present invention. The internal circuit 300 of the present embodiment includes, in addition to the configuration of the internal circuit 300 shown in FIG. 1, a multi-channel sampler 360, a transition detecting section 370, and a deserializer 380. The multi-channel sampler 360 outputs to the transition detecting section 370 the sampling results obtained by sampling the input signal with each of the internal clocks 312. The deserializer 380 samples the input signal according to the selected internal clock 312 to convert the input signal into a parallel signal. The converted signal is input to the comparing section 340. The comparing section 340 compares the input signal to the expected value output by the expected value generating section 350, and inputs the comparison results to the measuring section 140.

The transition detecting section 370 detects, for each internal clock 312, whether the logic value indicated by the sampling result in each cycle of the input signal has transitioned between the internal clock 312 and an internal clock 312 with an adjacent phase. Here, when an internal clock 312-k has a phase difference of (k−1)×Δφ relative to the internal clock 312-1, where k is an integer greater than or equal to 1, the internal clock 312-k and the internal clock 312-(k+1) have adjacent phases. In other words, the transition detecting section 370 compares the logic values indicated by sampling results for the internal clock 312-k and the internal clock 312-(k+1) to each other. When k is equal to the number of internal clocks 312, the transition detecting section 370 may compare the logic values of the sampling results for the internal clock 312-k and the internal clock 312-1 to each other.

For example, the transition detecting section 370 compares the sampling result for the internal clock 312-1 to the sampling result for the internal clock 312-2. When the sampling result for the internal clock 312-1 is “1” and the sampling result for the internal clock 312-2 is “0,” the transition detecting section 370 judges that the sampling result has transitioned. In the same way, when the sampling result for the internal clock 312-1 is “0” and the sampling result for the internal clock 312-2 is “1,” the transition detecting section 370 judges that the sampling result has transitioned.

While the phase control section 120 sequentially changes the phase of the reference clock, the transition detecting section 370 notifies the measuring section 140 concerning whether there is a transition at the sampling timing for each internal clock 312 at each phase. The measuring section 140 measures the jitter of the input signal based on the number of sampling result transitions detected by the transition detecting section 370 for each internal clock 312, at each phase of the reference clock.

Specifically, the measuring section 140 counts the number of transitions acquired from the transition detecting section 370, and calculates the cumulative distribution function of the phases in which a transition occurs, or of the timings at which a transition occurs. The measuring section 140 then calculates the probability density function based on the rate of change of the cumulative distribution function. The measuring section 140 may determine the jitter amount and the jitter type based on the calculated probability density function.

The internal circuit 300 of the present embodiment can sample the input signal using three internal clocks 312 simultaneously. Accordingly, sampling results can be obtained three times more effectively than when sampling with a single internal clock 312. Therefore, the signal generating section 170 can acquire the jitter distribution more quickly than when using a single internal clock 312.

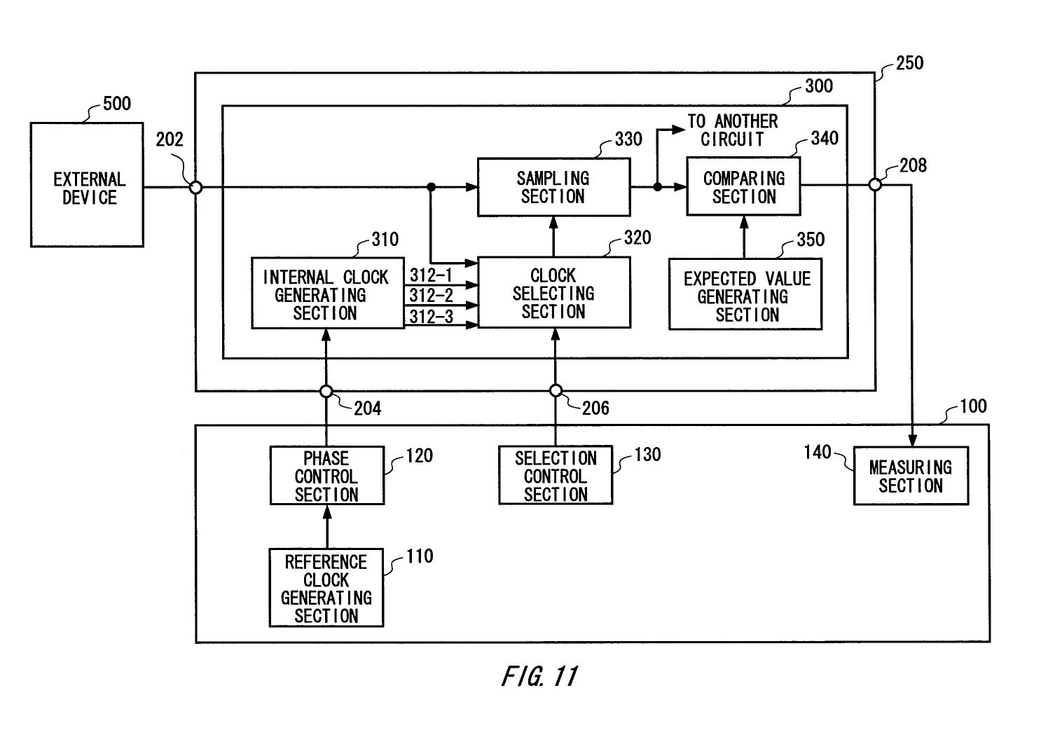

FIG. 11 shows configurations of the test apparatus 100, a testing device 250, and an external device 500 according to another embodiment of the present invention. An output signal from the external device 500 is input to the input pin 202 of the testing device 250. The test apparatus 100 can test a characteristic, such as jitter amount, of the output signal of the external device 500 by controlling the testing device 250 into which the output signal of the external device 500 is input.

For example, if the testing device 250 is a device in which the characteristic, such as jitter tolerance, of the internal circuit 300 is known, the test apparatus 100 can test the characteristic of the output signal of the external device 500 by measuring the sampling results output by the testing device 250. In the present embodiment, the testing device 250 compares the sampling results of the output signal of the external device 500 to an expected value. Accordingly, even when the operation frequency of the external device 500 exceeds the frequency that can be measured by the test apparatus 100, the characteristic of the output signal from the external device 500 can be measured if the operation frequency of the testing device 250 is high enough. The test apparatus 100 may include the testing device 250 therein.

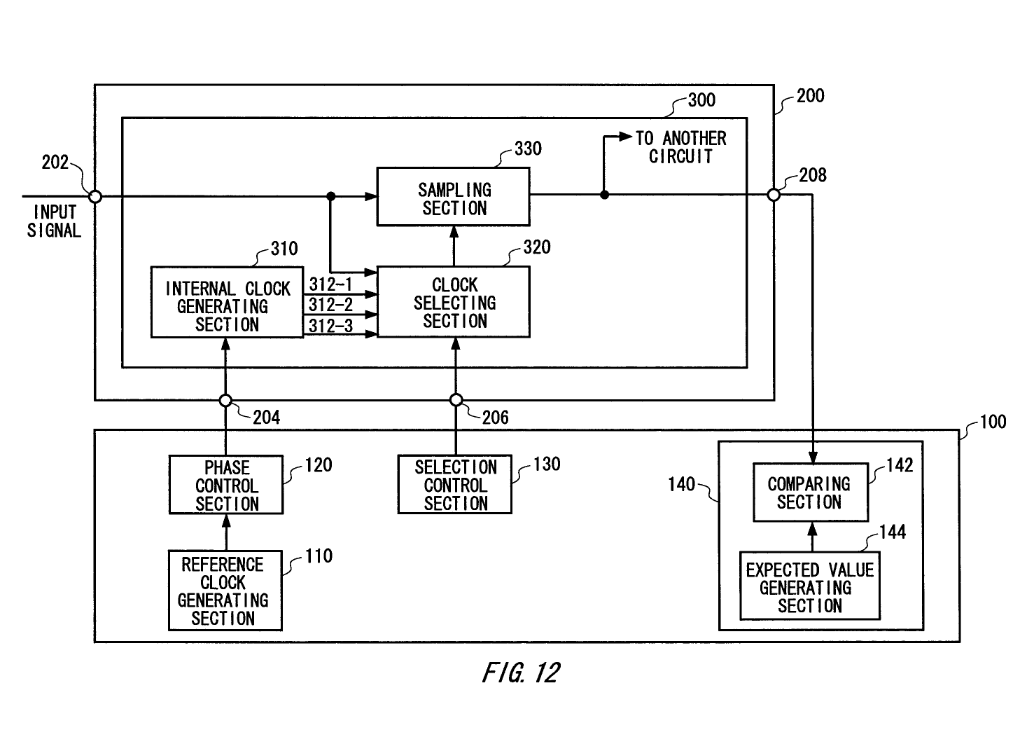

FIG. 12 shows configurations of the test apparatus 100 and the device under test 200 according to another embodiment of the present invention. The measuring section 140 of FIG. 12 includes, in addition to the configuration of the measuring section 140 shown in FIG. 1, a comparing section 142 and an expected value generating section 144. The device under test 200 inputs the sampling results of the sampling section 330 to the measuring section 140. The comparing section 142 and the expected value generating section 144 may have the same functions as the comparing section 340 and the expected value generating section 350 of the device under test 200 shown in FIG. 1.

The measuring section 140 acquires the sampling results from the sampling section 330, and compares the logic values of the sampling results to the expected value generated by the expected value generating section 144. The measuring section 140 may measure the jitter tolerance of the internal circuit 300 based on the comparison results.

The sampling section 330 converts the sampling results into parallel data, and inputs this parallel data to the measuring section 140. The expected value generating section 350 may input expected values for the parallel data into the comparing section 142. The comparing section 142 may measure the jitter tolerance of the internal circuit 300 by comparing the parallel data sampling results to the parallel data expected values.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention can be used to realize a test apparatus, a test method, and a device that improve the accuracy of measurement results for jitter or the like.

What is claimed is:

1. A test apparatus that tests a device under test, wherein
the device under test includes an internal circuit that generates a plurality of internal clocks having different phases based on a reference clock provided thereto, selects from among the internal clocks an internal clock having a predetermined relative phase with respect to an input signal having a frequency substantially equal to that of the internal clocks, and samples the input signal according to the selected internal clock, and
the test apparatus comprises:
a selection control section that fixes the internal clock selected by the internal circuit;
a phase control section that, with the selection of the internal clock being fixed by the selection control section, sequentially shifts the phase of the internal clock by inputting the reference clock to the device under test while sequentially shifting the phase of the reference clock outside of the device under test; and
a measuring section that measures a characteristic of at least one of the input signal and the internal circuit, based on the sampling result of the internal circuit.

2. The test apparatus according to claim 1, wherein
the device under test outputs a comparison result obtained by comparing the sampling result of the input signal to a predetermined expected value, and
the measuring section measures the characteristic of the input signal based on the comparison result.

3. The test apparatus according to claim 2, wherein
the measuring section measures at least one of jitter and an eye opening of the input signal, based on the comparison result.

4. The test apparatus according to claim 1, wherein
the device under test further includes a BIST control circuit that tests the internal circuit and an input/output port that transfers data between the BIST control circuit and the outside, and
the selection control section controls the internal circuit via the input/output port and the BIST control circuit to fix the internal clock selected by the internal circuit.

5. The test apparatus according to claim 1, further comprising:
a signal generating section that operates according to an operation clock supplied thereto to generate the input signal and input the input signal to the device under test;
an operation clock generating section that generates the operation clock and inputs the operation clock to the signal generating section; and
a reference clock generating section that generates the reference clock in synchronization with the operation clock and inputs the reference clock to the phase control section.

6. The test apparatus according to claim 1, wherein
the device under test further includes a signal generating section that operates according to an operation clock provided thereto to generate the input signal and loop the input signal back to the internal circuit, and
the test apparatus further comprises:
an operation clock generating section that generates the operation clock and inputs the operation clock to the signal generating section; and
a reference clock generating section that generates the reference clock in synchronization with the operation clock and inputs the reference clock to the phase control section.

7. The test apparatus according to claim 5, wherein
the reference clock generating section generates a clock with less jitter than the operation clock generated by the operation clock generating section.

8. The test apparatus according to claim 1, further comprising a signal generating section that generates the input signal and generates the reference clock in synchronization with the input signal, wherein
the phase control section controls the phase of the reference clock generated by the signal generating section and inputs the reference clock to the device under test.

9. The test apparatus according to claim 1, wherein
the device under test further includes a signal generating section that generates the input signal, loops the input signal back to the internal circuit, and generates the reference clock in synchronization with the input signal, and
the phase control section receives, outside of the device under test, the reference clock generated by the signal generating section, controls the phase of the received reference clock, and inputs the reference clock to the device under test.

10. The test apparatus according to claim 1, wherein
the selection control section sequentially changes which internal clock is fixed, and
the measuring section measures an eye opening of the input signal for each internal clock, and calculates a phase difference for each internal clock based on a position of the eye opening.

11. The test apparatus according to claim 1, wherein
the internal circuit further comprises:
a multi-channel sampler that outputs a plurality of sampling results obtained by sampling the input signal according to each internal clock;
a transition detecting section that detects, for each internal clock, whether the sampling result in each cycle of the input signal transitions between the internal clock and an internal clock with an adjacent phase;
a clock selecting section that selects one of the internal clocks based on the detection results of the transition detecting section; and
a deserializer that samples the input signal according to the selected internal clock, to convert the input signal into a parallel signal, and
for each phase of the reference clock, the measuring section measures jitter of the input signal based on a number of transitions of the sampling result detected by the transition detecting section for each internal clock.

12. A test apparatus for testing a device under test that generates a plurality of internal clocks having different phases based on a reference clock provided thereto and that samples an input signal having a phase that is the same as a phase of a selected one of the internal clocks, according to the selected internal clock, wherein
the device under test includes:
a multi-channel sampler that outputs a plurality of sampling results obtained by sampling the input signal according to each internal clock;
a transition detecting section that detects, for each internal clock, whether the sampling result in each cycle of the input signal transitions between the internal clock and an internal clock with an adjacent phase;
a clock selecting section that selects one of the internal clocks based on the detection results of the transition detecting section; and
a deserializer that samples the input signal according to the selected internal clock, to convert the input signal into a parallel signal, and
the test apparatus comprises:
a phase control section that sequentially shifts the phase of each internal clock by inputting the reference clock to the device under test while sequentially shifting the phase of the reference clock outside of the device under test; and
a measuring section that, measures jitter of the input signal for each phase of the reference clock, based on a number of transitions of the sampling results detected by the transition detecting section for each internal clock.

13. A test apparatus that tests a device under test, wherein
the device under test includes an internal circuit that generates a plurality of internal clocks having different phases based on a reference clock provided thereto, selects from among the internal clocks an internal clock having a predetermined relative phrase with respect to an input signal having a frequency substantially equal to that of the internal clocks, and samples the input signal according to the selected internal clock, and
the test apparatus includes:
a selection control section that fixes the internal clock selected by the internal circuit;
an operation clock generating section that, with the selection of the internal clock being fixed by the selection control section, sequentially shifts a phase between the input signal and the internal clock by inputting the input signal to the device under test while sequentially shifting the phase of the input signal outside of the device under test; and
a measuring section that measures a characteristic of at least one of the input signal and the internal circuit, based on the sampling result of the internal circuit.

14. A test method for testing a device under test, wherein
the device under test includes an internal circuit that generates a plurality of internal clocks having different phases based on a reference clock provided thereto, selects from among the internal clocks an internal clock having a predetermined relative phrase with respect to an input signal having a frequency substantially equal to that of the internal clocks, and samples the input signal according to the selected internal clock, and
the test method comprises:
fixing the internal clock selected by the internal circuit;
with the selection of the internal clock being fixed, sequentially shifting the phase of the internal clock by inputting the reference clock to the device under test while sequentially shifting the phase of the reference clock outside of the device under test; and
measuring a characteristic of at least one of the input signal and the internal circuit, based on the sampling result of the internal circuit.

15. A device that operates according to an input signal, comprising:
a multi-phase clock generating section that generates a plurality of internal clocks having different phases;
a multi-channel sampler that outputs a plurality of sampling results obtained by sampling the input signal according to each internal clock;
a clock selecting section that, when the device is operating, selects one of the internal clocks based on the sampling results of the multi-channel sampler, and, when the device is being tested, selects one of the internal clocks based on control from outside the device; and
a deserializer that samples the input signal according to the selected internal clock, to convert the input signal into a parallel signal.

16. The device according to claim 15, further comprising:
a BIST circuit that tests the operation of the deserializer; and
an input/output port that receives, from outside the device, a control signal for controlling the BIST circuit, wherein
the clock selecting section selects one of the internal clocks based on the control signal provided thereto from outside the device via the input/output port and the BIST circuit.

17. A test apparatus that tests an external device by controlling a testing device, wherein
the testing device includes an internal circuit that acquires an output signal output by the external device, generates a plurality of internal clocks having different phases based on a reference clock provided thereto, selects from among the internal clocks an internal clock having a predetermined relative phrase with respect to the output signal having a frequency substantially equal to that of the internal clocks, and samples the output signal according to the selected internal clock, and
the test apparatus includes:
a selection control section that fixes the internal clock selected by the internal circuit;
a phase control section that, with the selection of the internal clock being fixed by the selection control section, sequentially shifts the phase of the internal clock by inputting the reference clock to the testing device while sequentially shifting the phase between the output signal and the reference clock outside of the testing device; and
a measuring section that measures a characteristic of the output signal, based on the sampling result of the internal circuit.

18. A test method for testing an external device by controlling a testing device, wherein
the testing device includes an internal circuit that acquires an output signal output by the external device, generates a plurality of internal clocks having different phases based on a reference clock provided thereto, selects from among the internal clocks an internal clock having a predetermined relative phrase with respect to the output signal having a frequency substantially equal to that of the internal clocks, and samples the output signal according to the selected internal clock, and
the test method includes:
fixing the internal clock selected by the internal circuit;
with the selection of the internal clock being fixed, sequentially shifting the phase of the internal clock by inputting the reference clock to the testing device while sequentially shifting the phase between the output signal and the reference clock outside of the testing device; and
measuring a characteristic of the output signal, based on the sampling result of the internal circuit.
